(19) United States
(12) Patent Application Publication
(10) Pub. No.: US 2004/0025807 A1
(43) Pub. Date: Feb. 12, 2004

(54) Method of and an apparatus for supplying fuel to a vehicle

(76) Inventor: Shabier Jhetham, Lenasia (ZA)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/399,434

(22) PCT Filed: Oct. 12, 2001
(86) PCT No.: PCT/IB01/01909

(30) Foreign Application Priority Data
Oct. 17, 2000 (ZA) 2000/5753

(51) Int. Cl. F02B 43/12

(52) U.S. Cl. 123/3

(57) ABSTRACT

This invention relates to a method of supplying fuel to a vehicle engine (32). The method includes the steps of electrolytically generating hydrogen in an electrolytic cell (12) containing an electrolyte and two spaced apart electrodes (24) on board the vehicle (30), and feeding the hydrogen to the engine (32). The invention extends to an apparatus (10) for supplying fuel to an engine (32), which apparatus (10) includes an electrolytic cell (12), the cell (12) having an outlet (18) which is connectable in flow communication with a fuel intake of the engine (32).

THIS INVENTION relates to the use of hydrogen as a fuel. More particularly it relates to a method of and an apparatus for supplying fuel to a vehicle. It further relates to a vehicle.

The Inventor is aware that the use of hydrogen as a fuel is hampered by the difficulty of safely storing, transporting and distributing such a highly flammable, potentially explosive material.

It is an object of the present invention to provide a method and an apparatus which the Inventor believes will alleviate this problem.

According to a first aspect of the invention there is provided a method of supplying fuel to a vehicle engine which method includes the steps of

electrolytically generating hydrogen in an electrolytic cell containing an electrolyte and two spaced apart electrodes on board the vehicle; and

feeding the hydrogen to the engine.

In the context of this specification, “vehicle” is to be understood to include means for transporting people or goods by air, land or sea.

By electrolytic generation is meant generation by a process in which electrical energy is used to produce chemical change. The chemical change is brought about upon a chemical compound/composition, or its solution in water, which conducts electric current through ionisation, a so-called electrolyte. Electric current is conducted through the electrolyte, generally contained within a reservoir, by means of two electrodes of electrically conductive material. The electrical energy/current is provided by an external source.

The method may include electrolysing water. Instead, the method may include electrolysing an aqueous solution. The solution may be a basic aqueous solution. More particularly, the solution may be an aqueous sodium hydroxide solution. The solution may have a concentration of 1% (m/v).

Electric current for electrolysis may be supplied to the electrodes from an electrical system, e.g. a battery, of the vehicle. The electric current may be between about 4A and about 6A.

The electrolysis may be conducted by use of stainless steel electrodes.

The method may include cyclically reversing the polarity of the electrodes. The polarity of the electrodes may be reversed at a frequency of one cycle per minute.

The method may include the steps of monitoring the power demand of the vehicle and generating a power demand signal; and generating hydrogen at a rate which is determined by the power demand signal.

Where the engine is an internal combustion engine having a combustion chamber, the method may include mixing the hydrogen generated with air and feeding the mixture to the engine. The hydrogen may be fed into a combustion chamber of the engine via an inlet manifold of the engine. The hydrogen may be used to supplement a conventional liquid fuel such as petrol, diesel, methanol, or the like.

The method may include the step of periodically replenishing the electrolyte. The electrolyte may be replenished by way of an automatic feed of electrolyte from electrolyte supply means.

According to another aspect of the invention there is provided an apparatus for supplying fuel to an engine which apparatus includes an electrolytic cell for generating hydrogen by conducting electric current through an electrolyte by use of at least two electrodes, the cell having an outlet which is connected or connectable in flow communication with a fuel intake of the engine.

According to yet another aspect of the invention there is provided a vehicle which includes

an engine;

an electrolytic cell for generating hydrogen by conducting electric current through an electrolyte by use of at least two electrodes, the electrolytic cell having an outlet which is connected in flow communication with a fuel intake of the engine.

The electrolytic cell may be contained in a housing, the housing defining an electrolyte reservoir and having an outlet which leads from the housing at a high level and which is connectable to a fuel intake of the engine.

The housing may include an electrolyte inlet at a low level. An electrolyte flow control valve, displaceable between an open position, in which it permits the flow of electrolyte from an electrolyte supply through the inlet, and a closed position, in which it inhibits electrolyte flow through the inlet, may be provided upstream of the electrolyte inlet.

The cell may include electrolyte flow control valve actuating means for actuating the displacement of the valve between its open and closed positions.

The flow control valve actuating means may include an electrolyte level sensor which, in use, senses the level of electrolyte present in the housing, the flow control valve being actuated for displacement between its open and closed positions to maintain a more-or-less constant level of electrolyte in the housing.

The electrolyte supply may be in the form of an electrolyte tank in flow communication with the electrolyte inlet.

Typically, at least part of the housing through which the electrodes extend is manufactured of an electrically insulating material, such as polytetraflouroethene.

The vehicle may include a processor which monitors the fuel requirements of the engine and controls the electrolysis to produce the volume of hydrogen required by the engine.

The invention will now be described, by way of example, with reference to the accompanying diagrammatic drawings.

In the drawings:

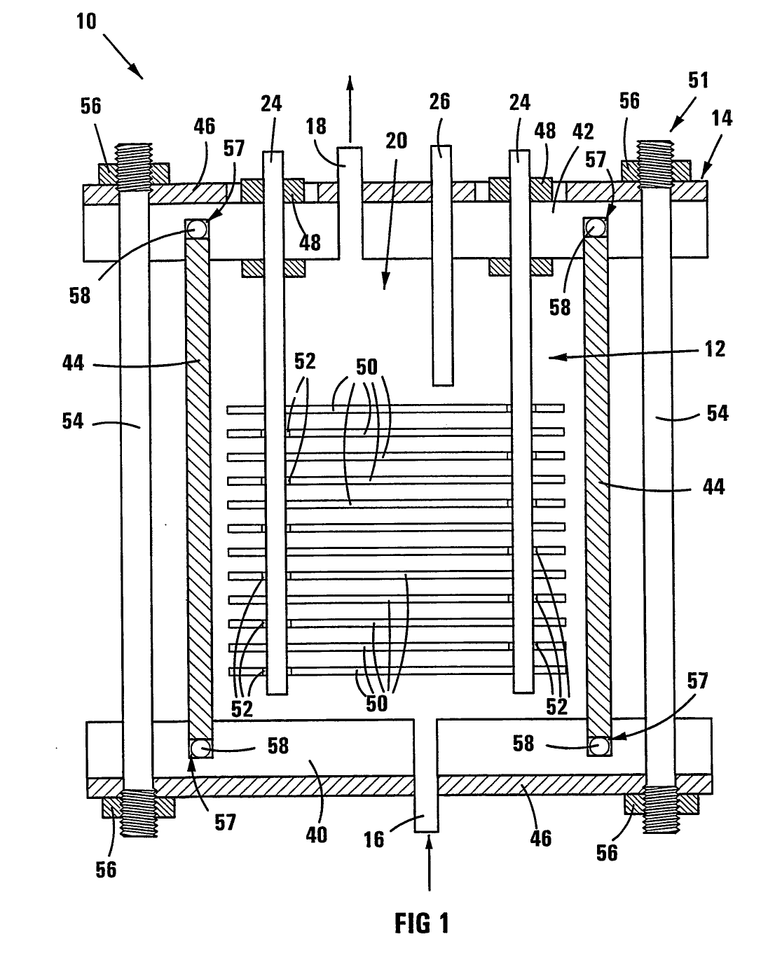

FIG. 1 shows a longitudinal sectional view of an apparatus for supplying fuel to an engine in accordance with the invention;

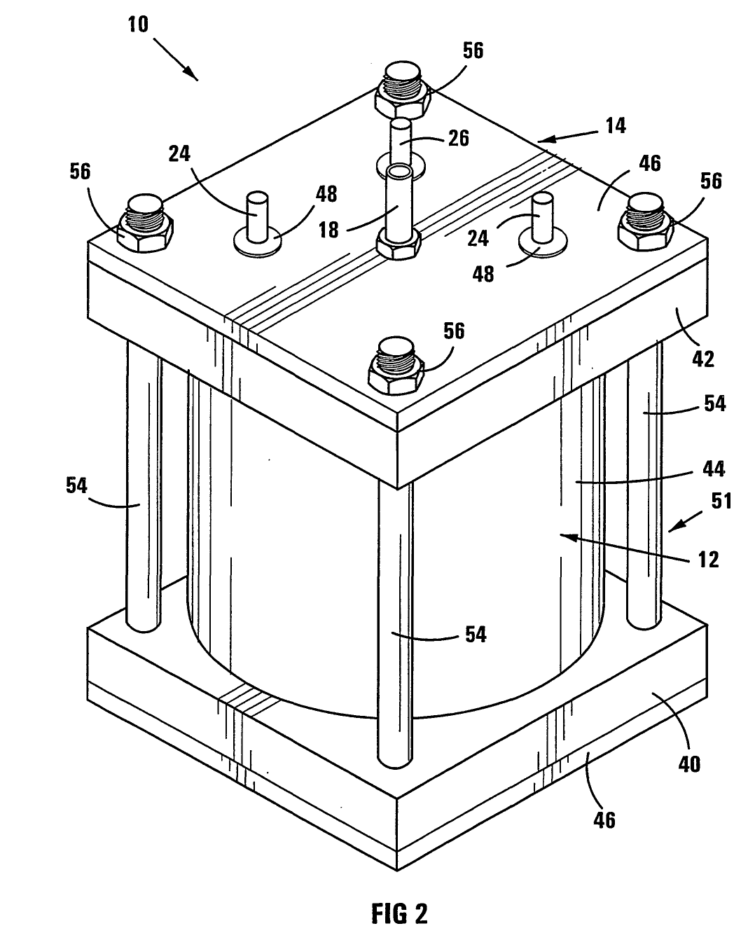

FIG. 2 shows a perspective view of the apparatus of FIG. 1;

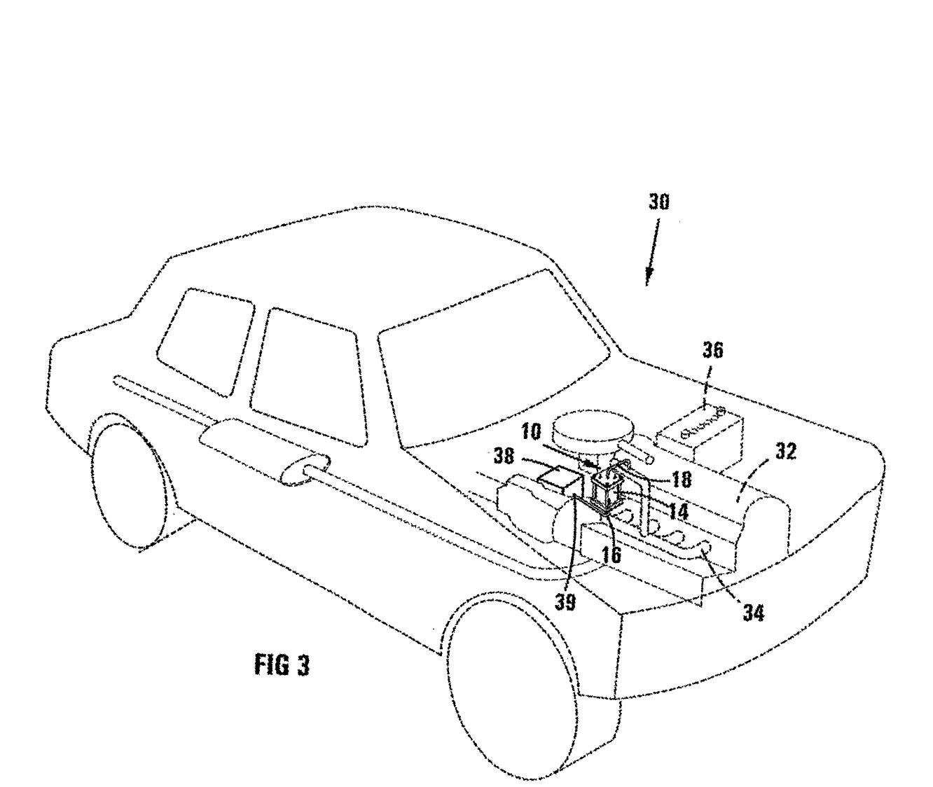

FIG. 3 shows a three-dimensional schematic view of a motor vehicle incorporating an apparatus for supplying fuel to an engine in accordance with the invention; and

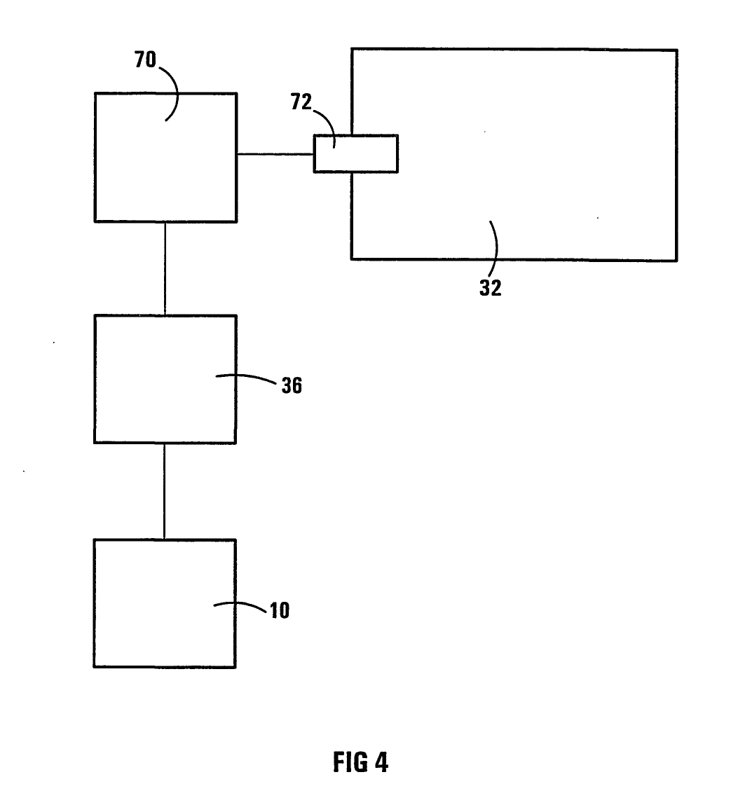

FIG. 4 shows a schematic representation of a fuel monitoring system forming part of a vehicle in accordance with the invention.

In FIGS. 1 and 2 of the drawings, reference numeral 10 refers generally to an apparatus for supplying fuel to an engine in accordance with the invention. The apparatus 10 includes an electrolytic cell, generally indicated by reference numeral 12. The electrolytic cell 12 is housed within a housing, generally indicated by reference numeral 14, which has an electrolyte inlet in the form of an inlet conduit 16 and an outlet 18 spaced from the inlet, which outlet 18 is connectable in flow communication with the fuel intake of the engine. The housing 14 defines a reservoir, generally indicated by reference numeral 20, for containing/holding an electrolyte.

The housing 14 includes a bottom wall 40, through which the electrolyte inlet 16 extends, and a top wall 42, through which the outlet 18 extends. The top and bottom walls 42, 40 are typically manufactured from polytetraflouroethene. However, it will be appreciated, that the top and bottom walls 40, 42 can be formed from any inert and electrically insulating material. The housing 14 further includes a circular cylindrical side wall 44 which extends between the bottom wall 40 and the top wall 42. Typically, the cylindrical side wall 44 is manufactured from stainless steel. Naturally, however, other materials could be used. The housing 14 includes an end plate 46 on each of the operatively outwardly facing surfaces of the top and bottom walls 42, 40. The end plates 46 are typically manufactured from stainless steel. Naturally, however, other materials could be used.

The housing 14 includes connecting means 51, for releasably connecting the top wall 42 (and its associated end plate 46), the cylindrical wall 44, and the bottom wall 40 (together with its associated end plate 46) together. The connecting means 51 is in the form of four shanks 54, each shank having a screw thread extending inwardly from each of its ends for part of its length. Each shank 54 passes through a hole defined in each of the top wall 42 and its associated end plate 46 and the bottom wall 40 together with its associated end plate 46. The top wall 42 and its associated end plate 46, the bottom wall 40 together with its associated end plate 46 and the shanks 54 are releasably connected together by means of nuts 56 which cooperate with the threaded ends of the shanks 54. Naturally, the connecting means 51 may take any suitable form.

End portions of the side wall 44 are positioned in complementary annular recesses 57 in the top and bottom walls 42, 40 respectively. The housing 14 includes a ring seal 58 positioned in each recess 57 to provide a fluid tight seal between each of the top wall 42 and the operatively upper end of the cylindrical side wall 44 and the bottom wall 40 and the operatively lower end of the cylindrical side wall 44.

The electrolytic cell 12 includes two spaced apart electrodes 24 which are mounted within the housing 14. The electrodes 24 are typically manufactured from stainless steel. Naturally, however, other electrically conductive materials could be used.

Each electrode 24 extends through the end plate 46 associated with the top wall 42, and the top wall 42, respectively. Each electrode 24 includes an insulating collar 48 at an operatively upper end of the electrode 24 for electrically isolating the electrode 24 from the stainless steel plate 46 and hence the other electrode 24. A series of parallel spaced apart sheets 50 of an electrically conductive material, for example, stainless steel, extend between the electrodes 24 within the housing 14, alternate sheets 50 being connected to and extending from opposite electrodes 24. Each sheet 50 has an aperture 52 defined therein, the aperture 52 being shaped and dimensioned to accommodate an electrode 24 therethrough. Therefore, each electrode 24 includes a series of spaced apart sheets 50 which extend outwardly therefrom. Each electrode 24 extends, with clearance, through the apertures 52 defined in the sheets 50 connected to the other electrode 24. It will be appreciated, that the sheets 50 serve to increase the effective surface area of each electrode 24.

An electrolyte flow control valve (not shown) is provided upstream of the electrolyte inlet and within the inlet conduit 16 for displacement between an open position in which it permits the flow of electrolyte from an electrolyte supply through the inlet conduit 16, and a closed position, in which it inhibits electrolyte flow through the inlet. The electrolytic cell 12 further includes electrolyte flow control valve actuating means, in the form of a sensing probe 26, mounted in the housing 14. The probe 26 is connected to the control valve to actuate the displacement of the valve between its open and closed positions. In use, the probe 26 senses the level of electrolyte 22 contained within the reservoir 20 and actuates the displacement of the valve from its closed position to its open position so as to maintain a more-or-less constant level of electrolyte 22 in the reservoir 20.

The portion of the housing 14 defining the outlet 18 is provided with connecting formations (not shown) whereby the outlet 18 is connectable in flow communication with the fuel intake of the engine.

Reference is now made to FIG. 3 of the drawings, in which reference numeral 30 refers generally to a motor vehicle and, unless otherwise indicated, the same reference numerals used above are used to designate similar parts. The motor vehicle 30 includes an engine 32 and a fuel intake which includes an inlet manifold 34 leading into the engine 32. The engine 32 shown is a four cylinder internal combustion engine. The motor vehicle 30 incorporates an apparatus for providing fuel to an engine 10 in accordance with the invention. An electrolyte (not shown) is contained within the housing 14. The electrolyte is typically a 1% (m/v) aqueous sodium hydroxide solution. Naturally, however, the electrolyte may be water or any other aqueous solution which, upon electrolysis thereof, generates hydrogen as a product. A battery 36 of the motor vehicle 30 is connected via conductors, providing an electrical current path, to each of the electrodes 24. Electrical current of between about 4A and about 6A is supplied to the electrodes 24 by the battery 36. In use, the electrical current is conducted through the electrolyte by means of the two electrodes 24. The polarity of the electrodes 24 is reversed at a frequency of about 1 cycle per minute. As the electrical current is conducted through the electrolyte, hydrogen gas is generated at one of the electrodes 24 and bubbles off. The hydrogen is fed through the outlet 18 and is mixed with air prior to being fed into the combustion chambers of the engine 32 via the inlet manifold 34 and is used to fuel the engine. If desired, instead of being used as the sole fuel, the hydrogen may be used to supplement a conventional liquid fuel such as petrol, diesel or the like.

The motor vehicle 30 includes electrolyte supply means in the form of an electrolyte tank 38 having an outlet 39 in flow communication with the electrolyte inlet 16 of the apparatus 10. When the electrolyte flow control valve (not shown) is displaced to its open position, electrolyte flow from the electrolyte tank 38 into the reservoir 20 is permitted.

In one embodiment of the invention, the motor vehicle 30 includes a processor 70 (FIG. 4) which is linked to a sensor 72 which monitors the fuel requirements of the engine 32, the processor 70 being configured to control the electrolysis in response to the fuel requirements so as to produce the correct volume of hydrogen required by the engine 32. To this end, the processor 70 is linked to the car battery 36, ie. to the electrical power supply of the vehicle 30, which varies the supply of power to the electrolytic cell 10, and thus the rate of electrolysis, in response to a signal generated by the processor 70.

It will be appreciated that the apparatus 10 can be mounted in flow communication with the inlet manifold 34 as part of the original equipment of the motor vehicle 30 when the vehicle is being manufactured. Instead, for existing vehicles, the outlet 18 can be connected in flow communication with the inlet manifold 34 with or without modification being made to the inlet manifold 34.

The Inventor believes that the apparatus for supplying fuel to a vehicle 10 in accordance with the invention will provide a safe means of storing hydrogen for fuelling a vehicle on board the vehicle since the hydrogen is only generated as and when it is required. In addition, the Inventor believes that the apparatus 10 will reduce the consumption of conventional liquid fuel by the vehicle. Further, the Inventor believes that the apparatus 10 will permit the replacement of conventional liquid fuel by hydrogen as a fuel with substantial ecological benefits.

1. A method of supplying fuel to a vehicle engine, which method includes the-steps of
electrolytically generating hydrogen in an electrolytic cell containing an electrolyte and two spaced apart electrodes on board the vehicle;
feeding the hydrogen to the engine; and
cyclically reversing the polarity of the electrodes at predetermined time intervals.

2. A method as claimed in claim 1, in which the polarity of the electrodes is reversed at a frequency of one cycle per minute.

3. A method as claimed in claim 1 or claim 2, in which the electrolyte is water.

4. A method as claimed in claim 1 or claim 2, in which the electrolyte is an aqueous solution.

5. A method as claimed in claim 4, in which the solution is a basic aqueous solution.

6. A method as claimed in claim 5, in which the solution is an aqueous sodium hydroxide solution.

7. A method as claimed in claim 6, in which the solution has a concentration of 1% (m/v).

8. A method as claimed in any one of the preceding claims, in which the electric current for electrolysis is supplied to the electrodes from a battery of the vehicle.

9. A method as claimed in claim 8, in which the electric current is between 4A and 6A.

10. A method as claimed in any one of the preceding claims, which includes the steps of
monitoring the power demand of the vehicle and generating a power demand signal; and
generating hydrogen at a rate which is determined by the power demand signal.

11. A method as claimed in any one of the preceding claims, which includes mixing the hydrogen with air and feeding the mixture to the engine.

12. A method as claimed in any one of the preceding claims, which includes the step of periodically replenishing the electrolyte.

13. A method as claimed in claim 12, in which the electrolyte is replenished by way of an automatic feed of electrolyte from electrolyte supply means.

14. An apparatus for supplying fuel to an engine, which apparatus includes an electrolytic cell for generating hydrogen by conducting electric current through an electrolyte by use of at least two electrodes, the cell having an outlet which is connectable in flow communication with a fuel intake of the engine and polarising means for cyclically reversing the polarity of the electrodes at predetermined time intervals.

15. An apparatus as claimed in claim 14, in which the electrolytic cell is contained in a housing, the housing defining an electrolyte reservoir and having an outlet which leads from the housing at a high level and which is connectable to a fuel intake of the engine.

16. An apparatus as claimed in claim 15, in which the housing includes an electrolyte inlet at a low level.

17. An apparatus as claimed in claim 16, which includes an electrolyte flow control valve upstream of the electrolyte inlet, the flow control valve being displaceable between an open position, in which it permits the flow of electrolyte from an electrolyte supply through the inlet, and a closed position, in which it inhibits electrolyte flow through the inlet.

18. An apparatus as claimed in claim 17, in which the electrolytic cell includes electrolyte flow control valve actuating means for actuating the displacement of the electrolyte flow control valve between its open and closed positions.

19. An apparatus as claimed in claim 18, in which the flow control valve actuating means includes an electrolyte level sensor which, in use, senses the level of electrolyte present in the reservoir defined by the housing, the flow control valve being actuated for displacement between its open and closed positions to maintain a more-or-less constant level of electrolyte in the reservoir.

20. An apparatus as claimed in any one of claims 17 to 19, inclusive, in which the electrolyte supply is in the form of an electrolyte tank in flow communication with the electrolyte inlet,

21. An apparatus as claimed in any one of claims 15 to 20, inclusive, in which at least part of the housing is manufactured of an electrically insulating material.

22. A vehicle which includes
an engine; and
an electrolytic cell for generating hydrogen by conducting electric current through an electrolyte by use of at least two electrodes, the electrolytic cell having an outlet which is connected in flow communication with a fuel intake of the engine and polarising means for cyclically reversing the polarity of the electrodes at predetermined time intervals.

23. A vehicle as claimed in claim 22, in which the electrolytic cell is contained in a housing, the housing defining an electrolyte reservoir and the outlet.

24. A vehicle as claimed in claim 23, in which the housing includes an electrolyte inlet at a low level.

25. A vehicle as claimed in claim 24, which includes an electrolyte flow control valve upstream of the electrolyte inlet, the flow control valve being displaceable between an open position, in which it permits the flow of the electrolyte from an electrolyte supply through the inlet, and a closed position, in which it inhibits electrolyte flow through the inlet.

26. A vehicle as claimed in claim 25, in which the electrolytic cell includes the electrolyte flow control valve actuating means for actuating the displacement of the electrolyte flow control-valve between its open and closed positions.

27. A vehicle as claimed in claim 26, in which the flow control valve actuating means includes an electrolyte level sensor which, in use, senses the level of electrolyte present in the reservoir defined by the housing, the flow control valve being actuated for displacement between its open and closed positions to maintain a more-or-less constant level of electrolyte in the reservoir.

28. A vehicle as claimed in any one of claims 25 to 27, inclusive, in which the electrolyte supply is in a form of an electrolyte tank in flow communication with the electrolyte inlet.

29. A vehicle as claimed in any one of claims 23 to 28, inclusive, in which at least part of the housing is manufactured of an electricly insulating material.

30. A vehicle as claimed in any one of claims 22 to 29, inclusive, which includes a processor which monitors a fuel requirement of the engine and controls the electrolysis to produce the volume of hydrogen required by the engine.

31. A method of supplying fuel to a vehicle engine as claimed in claim 1, substantially as herein described and illustrated.

32. An apparatus for supplying fuel to an engine as claimed in claim 14, substantially as herein described and illustrated.

33. A vehicle as claimed in claim 22, substantially as herein described and illustrated.

34. A new method, a new apparatus or a new vehicle, substantially as herein described.
